(19) United States
(12) Patent Application Publication
(10) Pub. No.: US 2010/0135809 A1
(43) Pub. Date: Jun. 3, 2010

(54) WIND WHEEL

(76) Inventor: Hermann Olschnegger, St.Peter (AT)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/594,504

(22) PCT Filed: Apr. 3, 2008
(86) PCT No.: PCT/AT2008/000121

§ 371 Date: Oct. 2, 2009

(30) Foreign Application Priority Data
Apr. 5, 2007 (AT) A 538/2007

(51) Int. Cl. F03D 11/00

(52) U.S. Cl. 416/179

(57) ABSTRACT

The invention relates to a wind wheel (1) for a low-speed wind power installation, comprising a plurality of rotor blades (2). In order to use said wind wheel during weak and gusty winds, the wind wheel (1) comprises at least one acceleration ring (3) connecting the rotor blades (2), for air acceleration in the normal direction in relation to the plane of the wind wheel (1).

The invention relates to a wind wheel for a low-speed wind power plant having multiple rotor blades according to the preamble of claim 1.

Wind power plants having multiple rotor blades are known and are used more and more frequently in alternative and environmentally-friendly energy production. Wind wheels having three rotor blades, which represent wind power plants for the high-energy range of the wind and have a rated power of up to 6 MW per wind power plant are widespread. A wind power plant of this type is typically well over 100 m tall and high levels of operating noise occur during operation because of the high peripheral velocity of the rotor blades of up to 300 km/h. This so-called velocity ratio, which represents the ratio between the velocity of the blade tip and the wind velocity, is typically in the range from six to eight in these plants. Wind power plants of this type are costly to produce and are therefore unprofitable for many areas of application and may only be set up at a predetermined distance to specific locations—in particular populated areas—because of the size and the noise generation.

Wind power plants for the low-energy range of the wind are often employed for use in a rated power range between 50 kW and 500 kW. These wind power plants may typically have a plurality, in particular more than three rotor blades, because air eddies in the area of a rotor blade only have little effect on the closest adjacent rotor blade. Via the plurality of rotor blades, the wind wheel can also use the wind power efficiently at lower angular velocity, i.e., at lower number of rotations per unit of time. The velocity ratio in operation always remains below five. Through the low-speed mode of operation and the lesser diameter of the wind wheel of these wind power plants, many disadvantages of the wind power plants for the high-energy range of the wind may be avoided, because of which wind power plants of this type for the low-energy range of the wind are becoming more and more popular in many areas of application and at many installation sites. A wind power plant for the low-energy range of the wind typically has a lesser overall height—for example, less than 50 m—than a wind power plant for the high-energy range of the wind.

However, the wind power plants used up to this point have the disadvantage that at low wind velocities, the wind wheel does not run stably and therefore a power output cannot occur. A gusty wind—which occurs increasingly above all close to the ground—often has a strong effect. In particular, large power variations occur upon a brief standstill of the wind wheel, because of which occurring lulls—often in weak to moderate wind—particularly strain the power network and therefore use is often not advisable under these conditions.

The object of the invention is therefore to disclose a wind wheel for a low-speed wind power plant of the type cited at the beginning, using which the cited disadvantages may be avoided and which can be used reasonably and efficiently in weak and gusty moderate winds.

This is achieved according to the invention by the features of claim 1.

The operation of the wind power plant can also be facilitated in weak winds by the acceleration ring. Through the accelerating effect of the air flow, the wind wheel can already be set into rotation at particularly low wind velocities, whereby weak winds are already usable for energy generation. Above all, this allows use at locations having—measured in the yearly average—moderate wind velocities and thus at locations having moderate air flow velocities and in the low-energy range of the wind. An efficiency improvement can thus be achieved in particular by the increase of the operating times.

Above all close to the ground, where the air flow also often ceases completely because of the increased gustiness, it is important that the wind wheel rotates further during a low air flow and a complete standstill does not occur. Electronic auxiliary units which prevent or delay the complete standstill of the wind wheel can be dispensed with by the acceleration ring. The construction can thus be simplified further and the production costs of the wind power plant may be reduced further.

A high force can already be transmitted to a hub at low wind velocities. According to the formula power is equal to torque times angular velocity, a high power is thus transmitted to the hub of the wind wheel even at low wind velocities. A particularly efficient and continuous operation of the wind power plant is thus ensured.

The acceleration ring for air acceleration causes acceleration of the air moved through the acceleration ring. This acceleration occurs in the direction perpendicular to the plane of the wind wheel. The at least regional acceleration of the wind in the projection area of the wind wheel can reduce the influence of wind gusts. A greater consistency of the output power can thus be made possible in gusty moderate wind. The power network is also strained less, whereby the use of the wind power plant is already advisable in air flows of lesser wind strength.

The subclaims, which simultaneously form a part of the descriptions, like claim 1, relate to further advantageous designs of the invention.

The acceleration ring 3 can replace a jacket of the wind wheel, whereby the air resistance of the wind wheel can be minimized and the efficiency can be maximized.

The operating pressure of the rotor blades can be displaced radially outward in the wind wheel—i.e., in the direction of the rotor tips. The work and, accompanying this, the power can thus be increased in constant wind. This is particularly advantageous above all in weak winds, whereby winds in the low-energy range may be used better for obtaining energy.

A partial vacuum, which is referred to hereafter as suction, arises behind the rotor blades through the acceleration of the air flow in the acceleration ring. The suction can particularly facilitate the start of the wind wheel even at low wind velocities and thus the efficiency of the wind wheel.

Furthermore, the stability of the wind wheel can be increased by the revolving acceleration ring. The reliable use of the wind power plant can thus also be made possible at higher wind velocities and the range of use of the wind power plant can be increased further. The yearly operating hours may thus be increased further and the yearly projected efficiency of the wind power plant can be improved.

The invention is described in greater detail with reference to the appended drawings, in which preferred embodiments are shown solely for exemplary purposes. In the figures:

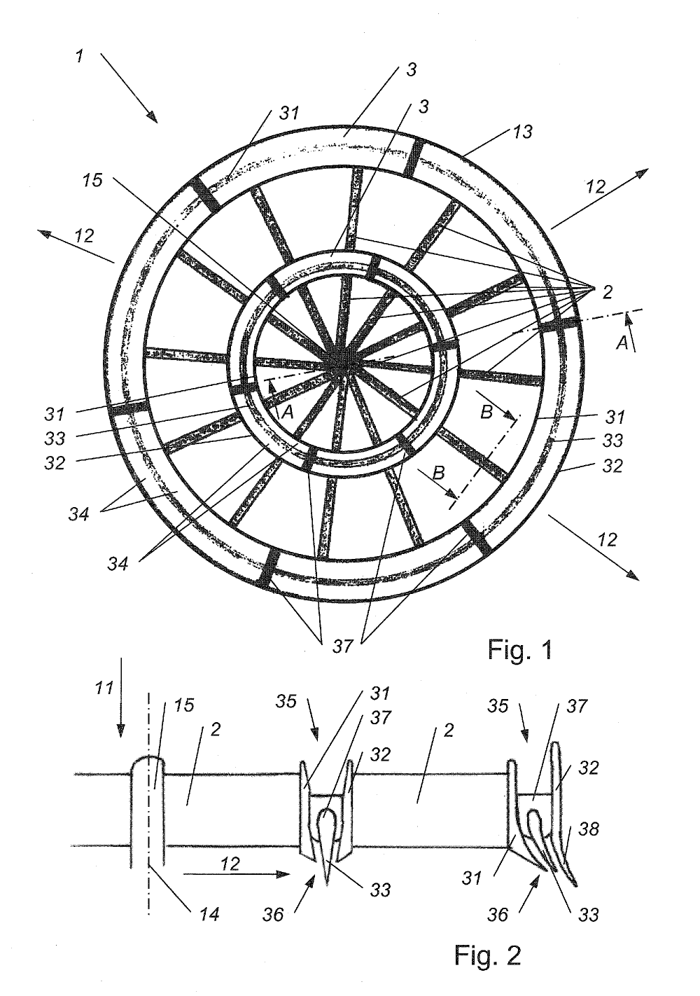

FIG. 1 shows a wind wheel of a first embodiment in a frontal view in a schematic illustration;

FIG. 2 shows a rotor blade and two acceleration rings—shown in section along line A-A of FIG. 1—in a schematic illustration;

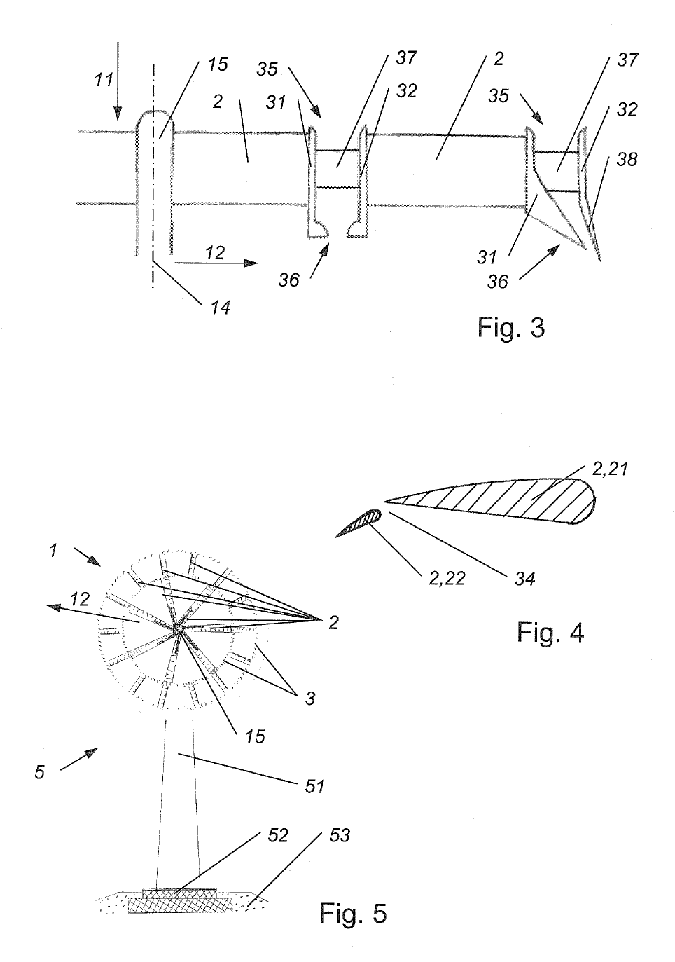

FIG. 3 shows a rotor blade and two acceleration rings of a second embodiment, which is shown in a schematic illustration similar to FIG. 2;

FIG. 4 shows a rotor blade—shown in section perpendicular to the longitudinal extension of the rotor blade and along line B-B of FIG. 1—having a first flow-around body and a second flow-around body, and

FIG. 5 shows a wind power plant comprising a wind wheel according to the invention of a third embodiment in a schematic illustration.

FIGS. 1 through 5 show embodiments of a wind wheel 1 for a low-speed wind power plant 5 having multiple rotor blades 2, the wind wheel 1—for air acceleration in the direction perpendicular to the plane of the wind wheel 1—having at least one acceleration ring 3 of the wind wheel 1, which connects the rotor blades 2.

The wind wheel 1, which can also be referred to as a rotor or propeller, is connected using a hub 15 to the generator of the wind power plant 5 and is mounted so it is rotatable around a central axis 14. The wind power plant 5 can also be referred to as a wind energy plant, or as a wind or wind energy power plant.

The wind wheel 1 has a plurality, in particular four or more rotor blades 2. Energy can thus already be withdrawn from the air flow at a low number of revolutions, which can be measured in revolutions of the wind wheel 1 per minute.

At least one acceleration ring 3 is provided in the wind wheel 1. This acceleration ring 3, which is spaced apart around the entire rotor circumference and essentially radially constant to the central hub 15, causes an additional acceleration in the through flow direction of 11 of the air masses passing through the acceleration ring 3 parallel to the central axis 14 of the wind wheel 1, acceleration being understood as a velocity increase. The wind wheel can thus already be set into rotation at low wind velocities, whereby weak winds may already be used for generating energy. The rotor blades 2 may also be referred to as wind wheel blades and/or as propeller blades. The number of the operating time can often be elevated significantly, whereby the achieved power output is increased. A high reliability of the provision of energy on demand can be achieved in particular.

The wind wheel 1 is usually situated on the windward side relative to the tower 51. Pressure energy is converted into kinetic energy by the acceleration ring 3, a partial vacuum being implemented behind acceleration ring 3—viewed in the direction of the central axis 14. In this way, suction arises behind the acceleration ring 3 and behind the rotor blades 2 in the direction of the central axis 14. The suction causes good operating behavior and high efficiency, in particular also at low wind velocities.

It can advantageously be provided that the acceleration ring 3 comprises at least one first guiding element 31 and one second guiding element 32, the first guiding element 31 and the second guiding element 32 being spaced apart from one another viewed in the radial direction 12 of the wind wheel 1 and implementing an air passage 34 in the direction perpendicular to the plane of the wind wheel 1.

FIG. 1 shows a wind wheel 1 of a first embodiment in frontal view in a schematic illustration. The hub 15, twelve rotor blades 2, two acceleration rings 3, six spacers 37 per acceleration ring 3, multiple air passages 34 of the acceleration rings 3, the first guiding elements 31, the second guiding elements 32, the third guiding elements 33, the radial direction 12, which points away from the center and from the hub of the wind wheel 1, and an outer edge 13 of the wind wheel 1 are shown. A smoothing effect of the flow behind the wind wheel 1 can be achieved by the third guiding elements 33.

The cross section of the air passage 34 can—viewed in the through flow direction of 11 perpendicular to the plane of the wind wheel 1 (not shown in FIG. 1)—have an area tapering the air passage 34. In this way, the air acceleration of the air masses passing through the acceleration ring 3 is made possible particularly effectively and the suction effect in the area—viewed in need through flow direction 11—is subsequently ensured behind acceleration ring 3 and behind the rotor blades 2. A rotation of the wind wheel 1 can thus already be ensured at low wind velocity or low velocity of the air flow. Through the expansion of the advisable range of use—above all in relation to the range of the wind strength or the wind velocity—of the wind wheel 1, the average efficiency and the yearly output can be increased using simple and cost-effective means. In particular, use can thus already be made possible at wind velocities of approximately 2.5 m/s, advantageously 2 m/s, in particular 1.5 m/s.

Furthermore, it can be provided that the cross section of the first guiding element 31 and/or the cross section of the second guiding element 32 are implemented as essentially streamlined and the air resistance is thus decreased and the efficiency of the acceleration ring 3 is elevated further. The third guiding element 33 and/or the spacer 37 can also be implemented as streamlined, whereby the air resistance can be minimized further. In this way, the air resistance of these guiding elements 31, 32, 33 is low and the efficiency is high.

In FIG. 1, the 12 rotor blades 2 are implemented as radially adjacent at an angle of 30° each to the closest adjacent rotor blade 2. The rotor blades 2 may be implemented identically in one embodiment or, in particular with an even number of rotor blades 2, be implemented in two or more different embodiments of the rotor blades 2. The different embodiments of the rotor blades 2 may particularly be implemented alternately along the circumference of the wind wheel 1. Rotor blades 2 optimized for operation at low wind velocities may be implemented alternately with rotor blades 2 optimized for operation at high wind velocities. In this way, the power output of the wind wheel 1 and the wind power plant 5 can be ensured over a large wind range. This can be particularly advantageous in power networks which react sensitively to power variations. The output of the current can thus be predetermined better and above all in a large wind velocity range, whereby a higher percentage component of wind energy is made possible in the power network connected to the wind power plant 5. Further possible uses for a wind power plant according to the invention may thus be developed.

Two acceleration rings 3 are shown in FIG. 1. One of the two is implemented closer to the hub 15 than to the outer edge 13—viewed in the radial direction 12. The other of the two acceleration rings 3 is implemented as the outer edge 13 of the wind wheel 1. This advantageous positioning of the two acceleration rings 3 can influence the operating point of the air flow along the rotor blades 2. The operating point, which refers in this context to the point on the rotor blade 2 having the greatest interaction between the air flow flowing through in the through flow direction 11 and the rotor blade 2, can be shifted in the radial direction 12 in the direction of the outer edge 13 of the wind wheel 1. A greater torque can thus be transmitted to the generator and the power can be elevated at constant number of revolutions of the wind wheel 1 or the number of revolutions of the wind wheel 1 can be decreased at constant power. Upon a reduction of the number of revolutions, the noise development of the rotor blades 2, the wind wheel 1, and the wind power plant 5 can also be reduced, which facilitates and/or makes possible use close to populated areas and/or recreational areas.

In other embodiments of the wind wheel 1, only one acceleration ring 3 or a larger number of acceleration rings 3 may also be provided. With only one acceleration ring 3, it is preferably situated at the outer end of the rotor blades 2.

The first guiding element 31 and the second guiding element 32 may be connected to one another using at least one spacer 37. The spacers 37 shown in FIG. 1 are advantageously selected in their position and number. On the one hand, there are to be as few spacers 37 as possible in order to reduce the air resistance. On the other hand, these spacers 37 are to allow the greatest possible stiffness of the wind wheel 1. For this purpose, the number of the spacers 37 can correspond to precisely half of the number of the rotor blades 2 and it can advantageously be provided that the cross section of the at least one spacer 37 is implemented as streamlined. The individual spacers 37 may be implemented as spaced apart at an equal distance to the particular two adjacent rotor blades 2. In this way, all spacers 37 of one acceleration ring 3 are spaced apart equally from the two particular adjacent rotor blades 2, whereby tension peaks are avoided in the wind wheel 1 and the wind wheel can be designed optimally for the entire predetermined usage range. The usage range, i.e., the wind range in which the wind power plant 5 can be operated and can output power into the power network, can also be expanded to high wind velocities, for example, 12 m/s, advantageously 15 m/s, particular 18 m/s by the high stiffness of the wind wheel 1.

The usage range can be expanded to both low wind velocities and also high wind velocities by the combination of several of the above-mentioned features, whereby usage is made possible at wind velocities between, for example, 2.5 to 12 m/s, advantageously 2 to 15 m/s, in particular 1.5 to 18 m/s.

FIG. 2 shows a top view of the hub 15, one complete rotor blade 2, and two acceleration rings—shown in section—of the wind wheel 1 in a schematic illustration. The hub 15 is attached along a central axis 14. The central axis 14 represents the rotation center point of the wind wheel 1. The rotor blades 2 are connected to the hub 15 and are implemented as star-shaped radially outward therefrom.

The rotor blade 2 shown in FIG. 2 is penetrated after a predetermined distance by one of the two acceleration rings 3. It can be provided that—viewed in the radial direction 12 of the wind wheel 1—rotor blades 2 are situated on both sides of the acceleration ring 3. This acceleration ring 3, which is situated inside the wind wheel 1 and can therefore also be referred to as an internal acceleration ring 3, comprises a first guiding element 31, a second guiding element 32, and a third guiding element 33, the guiding elements 31, 32, 33 being implemented as streamlined. The spacer 37—also shown in section—is also implemented as streamlined. The air resistance is low and the efficiency of the acceleration ring 3 is high.

The acceleration ring 3 has a tapering area between the first guiding element 31 and the second guiding element 32. The open cross section of the acceleration ring 3 in a windward area 35, i.e., viewed from the imaginary center of the rotor blade 2 toward the wind and thus opposite to the direction of the wind, is greater than the open cross section in a lee side area 36, i.e., viewed from the imaginary center of the rotor blade 2 in the direction of the wind. In this advantageous embodiment, the third guiding element 33 is situated in the lee side area 36. This third guiding element 33 is adapted in its design to the first guiding element 31 and the second guiding element 32. The third guiding element 33 additionally implemented in this area divides the air flow in the acceleration ring 3 into two individual air flows. A flow through a tapering area can in turn occur in each of these individual air flows—viewed in the through flow direction 11 perpendicular to the plane of the wind wheel 1. The air flowing through the acceleration ring 3 is accelerated and high efficiency of the acceleration ring 3 is ensured. In particular, the air flow can be accelerated at low wind velocities, whereby the rotation of the wind wheel 1 and the power output are ensured even at low wind velocities and the efficiency of the wind power plant 5 can be ensured in particular in this wind range.

The cross section of the third guiding element 33 can be implemented as streamlined, whereby the air resistance of the acceleration ring 3 can be kept low and turbulent flow states can be avoided.

Different exit velocities may optionally also be achieved in the individual air flows divided by the third guiding element 33. Particularly good smoothing of the flow behind the wind wheel 1 can thus be achieved.

It can advantageously be provided that the third guiding element 33 is implemented to deflect the flow in the radial direction 12. The operating point, in particular the pressure point of the wind attack surface, can thus be shifted. The power output can thus be kept constant over a wind velocity range and/or the optimum operating point for each of these wind velocities can be set using simple means in this way. The high efficiency of the wind power plant can be ensured in a wide wind strength range, i.e., in a wide range of the wind velocity.

It can advantageously be provided that the acceleration ring 3 is situated essentially on the outer edge 13 of the wind wheel 1. Because the acceleration ring 3 is situated on the outer edge 13 of the wind wheel 1 in this configuration, it can also be referred to as an external acceleration ring 3. The external acceleration ring 3 can particularly advantageously be situated in addition to an internal acceleration ring 3, which interrupts the rotor blades 2. In a large wind wheel 1, multiple internal acceleration rings 3 may also be implemented. The maximum advisable number of internal acceleration rings 3 results from the cross-sectional area in the through flow direction 11 of the wind wheel 1, a ratio of the cross-sectional area of the wind wheel 1 and the sum of the cross-sectional areas of the acceleration rings 3 not falling below two to one, i.e., for example, three to one or more being maintained.

With this advantageous configuration of the acceleration ring 3 in the area of the outer edge 3 of the wind wheel 1, it can be provided that the acceleration ring 3 has a diffuser 38 on its outer end—viewed in the radial direction 12 of the wind wheel 1. Turbulence, which reduces the efficiency, may thus be avoided.

In a particularly advantageous embodiment of the invention, it can be provided that the cross section of the rotor blades 2 is at least regionally implemented in two parts and comprises a first flow-around body 21 and at least one second flow-around body 22, which is spaced apart from the first flow-around body 21, the second flow-around body 22 being situated downstream from the first flow-around body 21—viewed in the through flow direction 11. A lift effect can thus be made possible on the rotor blades 2 even at particularly low passage velocities of the air flow and rotation of the wind wheel 1 can already occur at particularly low wind velocities. Above all, the efficiency can thus be increased at low wind velocities and the rated power of the wind power plant 5 can already be achieved at low wind velocities. In this way, the rated power in the yearly average can be output over a particularly long period of time, whereby a predetermined power can be output into the power network with less variation with over this long period of time.

The first flow-around body 21 and/or the second flow-around body 22 can be fastened at one end on the hub 15 and at the other end, which is opposite to the first end, on the acceleration ring 3. This allows particularly simple installation and cost-effective design, which is optimized for the surface cross section, of the first and/or second flow-around body 21, 22. Through the installation at both ends of the longitudinal extension of the first and/or second flow-around bodies 21, 22, the strains occurring at these installation points may be kept low, whereby the strain of the components in the area of these installation points is low, and a long service life and minimum maintenance effort of these components can be ensured.

In this context, it can be provided that the cross section of the first flow-around body 21 is implemented as streamlined, and/or the cross section of the second flow-around body 22 is implemented as streamlined.

The guiding elements 31, 32 may project beyond the rotor blades 2, whereby eddying can be effectively prevented in the area directly behind the rotor blades 2.

If the acceleration ring 3 is situated on the outer end of the wind wheel 1, it can be ensured by an asymmetrical implementation, the outer guiding element 32 protruding further on the wind entry side, that a wind incident on the wind wheel 1 is not deflected outward around the wind wheel 1.

An embodiment without third guiding element 33 is shown in FIG. 3. An acceleration of the air flow is achieved by the tapering area.

A rotor blade 2 according to the invention having a first flow-around body 21 and a second flow-around body 22 is shown in section in FIG. 4, the first flow-around body 21 and the second flow-around body 22 being implemented as streamlined. The through flow area 34 is provided between the two flow-around bodies 21, 22. A lift force, which can set the wind wheel 1 into rotation, is already implemented at low wind velocities by this configuration of the two streamlined flow-around bodies 21, 22. The wind wheel 1 can already operate energy-efficiently at low wind velocities and the wind power plant 5 can already convert low wind energy into electrical power.

In this context, it can be provided that the first flow-around body 21 is situated fixed in the wind wheel 1, and the second flow-around body 22 is situated so it is movable around an essentially radial axis of the wind wheel 1. The power output of the wind power plant 5 can thus be ensured over a large wind strength range, for example, in the range of a wind velocity from 1 m/s to 18 m/s.

In an advantageous refinement of the invention, it can be provided that—viewed in the through flow direction 11—the length of the second flow-around body 22 is approximately 10% to approximately 50%, preferably approximately 12% to approximately 30%, in particular approximately 15% to approximately 25%, of the length of the first flow-around body 21. Area ratios of the surfaces of the two flow-around bodies 21, 22 which are adapted to one another thus result, whereby the optimum wind strength range can be predetermined and optimum efficiency can be ensured over a large wind strength range.

Furthermore, the use of the wind power plant 5 in the ultralow-energy range of the wind is conceivable, i.e., at wind velocities between 1.5 m/s and 6 m/s, advantageously between 2 m/s and 6 m/s, in particular between 2.5 m/s and 6 m/s. In this context, the rotor blades 2 may advantageously be implemented having a two-part or multipart cross section over their entire longitudinal extension from the hub 15 to the outer edge 13, in particular up to the acceleration ring 3 in the area of the outer edge 12. The cross section may be implemented at least regionally as at least three-part or four-part. The effective power can thus be implemented as high above all in the range of low wind velocities. At these wind velocities, the air resistance, which rises with the number of cross-sections, which are spaced apart from one another, of a rotor blade 2, can additionally contribute to obtaining energy.

However, in this design—also because of the large air resistance—the efficiency would decrease at higher wind strength. The possible wind velocity usage range of a design of this type of the rotor blade geometry may be in the wind velocity range from 1.5 m/s to 6 m/s. Wind wheels 1 having a large number of rotor blades 2, for example, more than 12, are particularly advantageous in this context.

FIG. 5 shows a wind power plant 5 comprising a further embodiment of the wind wheel 1 according to the invention. In this example, seven rotor blades 2 are implemented in the area between hub 15 and the internal acceleration ring 3. Double the number of rotor blades 2—in this case 14—is provided between the internal acceleration ring 3, which has a diameter of approximately 60% of the diameter of the wind wheel 1, and the external acceleration ring 3, whose diameter approximately corresponds to the diameter of the wind wheel 1. Material and weight are thus saved in the wind wheel 1. The air resistance in the through flow direction 11 can be minimized in the area of the hub 15 and in an area around the hub 15.

Diffusers 38 may also be provided at least in the area of one of the two acceleration rings 3 in this advantageous embodiment.

The multiple acceleration rings 3 which the wind wheel 1 according to the invention comprises may advantageously be implemented having constant and/or identical width—in the radial direction 12. Optimum adaptation of the geometry of the acceleration ring 3 to the mean wind velocity—in particular at the location of the wind power plant 5—is made possible in this way.

It can also be provided that the multiple acceleration rings 3 each have an equal cross section—viewed in the through flow direction 11. In this way, a constant acceleration effect of the acceleration rings 3 can be ensured over a large wind strength range. Above all, the power variations occurring due to wind gusts may be kept low, whereby a power output of the wind power plant 5 is made possible over a large wind velocity range. The acceleration rings 3 elevate the stiffness of the wind wheel 1, because of which the rotor blades 2 may be implemented simply and cost-effectively to achieve optimum conditions of surface geometry.

Means for controlling the setting of the rotor blades 2 to the wind may advantageously be provided in the acceleration ring 3. The rotor blade setting can thus be changed easily and cost-effectively. The rotor blades 2 between hub and closest acceleration ring 3 and the rotor blades 2 between the acceleration ring 3 situated in an area of the outer edge 13 and the acceleration ring 3 closest thereto may advantageously be controlled independently of one another, in particular in their setting to the wind. The efficiency of the rotor blades can thus be optimized over the entire radial extension of the wind wheel 1 in a large velocity range of the air flow.

Further embodiments according to the invention only have a part of the described features, any feature combination, in particular also of various described embodiments, being able to be provided.

1.-15. (canceled)

16. A wind wheel for a low-speed wind power plant, comprising:
multiple rotor blades; and
at least two acceleration rings connecting the rotor blades for air acceleration in a direction perpendicular to a plane of the wind wheel, each said acceleration ring comprising first and second guiding elements spaced apart from one another in a radial direction of the wind wheel and forming an air passage in the direction perpendicular to the plane of the wind wheel,
wherein one of the acceleration rings is arranged essentially on an outer edge of the wind wheel to define an external acceleration ring, and the other one of the acceleration rings defines an internal acceleration ring disposed to interrupt the rotor blades.

17. The wind wheel of claim 16, wherein the internal acceleration ring has a diameter which is approximately 60% of a diameter of the wind wheel.

18. The wind wheel of claim 16, further comprising more than one of said internal acceleration ring.

19. The wind wheel of claim 16, wherein the air passage has in a through flow direction perpendicular to the plane of the wind wheel a cross section configured to have an area which tapers the air passage.

20. The wind wheel of claim 16, wherein at least one of the first and second guiding elements has a cross section with an essentially streamlined configuration.

21. The wind wheel of claim 16, further comprising a third guiding element arranged in a lee side area.

22. The wind wheel of claim 21, wherein the third guiding element is constructed to deflect a flow in the radial direction.

23. The wind wheel of claim 16, further comprising a spacer connecting the first and second guiding elements to one another.

24. The wind wheel of claim 23, wherein spacer has a cross section of streamlined configuration.

25. The wind wheel of claim 23, wherein the spacer is situated spaced apart equally to each two adjacent rotor blades.

26. The wind wheel of claim 16, further comprising a hub, wherein seven of said rotor blades are situated between the hub and the internal acceleration ring, and wherein fourteen of said rotor blades are situated between the internal acceleration ring and the external acceleration ring.

27. The wind wheel of claim 16, wherein each said acceleration ring has a diffuser on an outer end thereof as viewed in the radial direction of the wind wheel.

28. The wind wheel of claim 16, wherein rotor blades are situated on both sides of each said acceleration ring as viewed in the radial direction of the wind wheel.

29. The wind wheel of claim 16, wherein a cross section of the rotor blades is at least regionally implemented in two parts and comprises a first flow-around body and at least one second flow-around body which is spaced apart from the first flow-around body, said second flow-around body being situated downstream from the first flow-around body as viewed in a through flow direction.

30. The wind wheel of claim 29, wherein at least one of the first and second flow-around bodies has a cross section of streamlined configuration.

31. The wind wheel of claim 29, wherein the first flow-around body is securely fixed in the wind wheel, and the second flow-around body is arranged for movement around an essentially radial axis of the wind wheel.

32. The wind wheel of claim 29, wherein the second flow-around body has a length which is approximately 10% to approximately 50% of a length of the first flow-around body as viewed in the through flow direction.

33. The wind wheel of claim 29, wherein the second flow-around body has a length which is approximately 12% to approximately 30% of a length of the first flow-around body as viewed in the through flow direction.

34. The wind wheel of claim 29, wherein the second flow-around body has a length which is approximately 15% to approximately 25% of a length of the first flow-around body as viewed in the through flow direction.
